(19) United States
(12) Patent Application Publication
(10) Pub. No.: US 2014/0334269 A1
(43) Pub. Date: Nov. 13, 2014

(54) Shot Activated Timer System and Method

(71) Applicant: DOUBLE-ALPHA ACADEMY B.V., Waalwijk (NL)

(72) Inventor: Kirsch Saul, Waalwijk (NL)

(73) Assignee: Double-Alpha Academy B.V., Waalwijk (NL)

(21) Appl. No.: 13/891,547

(22) Filed: May 10, 2013

(51) Int. Cl. G04F 8/00

(52) U.S. Cl. CPC G04F 8/006
USPC 368/1

(57) ABSTRACT

A shot activated timer system comprises a wearable housing in which control and processing components are in electrical communication with a display, input devices, a power source, a stopwatch, a motion sensor, activation signal components, optional wireless communication components, and optional audio sensors. The motion sensor detects the vibration patterns when a firearm is discharged, and pattern recognition software installed on the control and processor components identifies valid firearm shots. The system communicates with a base unit using a short-range communication protocol. The time it takes for a shooter to discharge his firearm is measured by recording the elapsed time from an activation signal until a shot is fired. When the firearm discharges, the vibration of the shot is sensed by the motion sensor and optionally additionally with the audio sensor. One or more sequential shots can be recorded, and the results can be delivered to the display.

### FIELD OF THE INVENTION

The present invention relates to a method and apparatus for timing firearm shots. In particular, the present invention relates to a wearable shot activated timer system that measures vibrations and sound.

### BACKGROUND OF THE INVENTION

In the sport of competitive shooting, one of the factors by which an athlete is measured is time. In order to measure accurately the shooting time, a shot activated timer (also known as shot timer) is used. Currently available shot timers measure the shooter's shooting time with a microphone that senses the shots. Typically, the shooter begins shooting after he hears an audio signal, such as a simple beep, that is generated by the shot timer. When the audio signal is produced, simultaneously an internal stopwatch begins to run. As the shooter shoots, the typical shot timer senses each shot with the microphone and accordingly records the elapsed time. One or more shots are recorded, and the last shot time recorded represents the overall shooting time. The timer continues to run until it is manually stopped, until the clock reaches its maximum time, which is typically 999 seconds, or until a new session is started. While the timer shows on a main display what the last shot recorded is, in the background the timer continues to run, the microphone continues to listen, and the display will update if a new shot is detected.

Unfortunately, because currently shot timers measure only sound, they are not as useful among groups of shooters who are training together. Shooters may be training together or actively engaged in a multi-shooter competition or practice. Often the competitor or training shooter will not have the entire range to himself, but only one shooting lane. For example, the training shooter is in one lane and in adjacent lanes are other shooters. In these cases, each shooter is firing shots and currently available shot timers are not able to easily distinguish one shooter's shots from another shooter's shots. The currently available shot timers instead record all nearby shots as if they came from a single shooter. Consequently, the results recorded by the shot timer are unusable for competition or training.

For the above reasons, it would be desirable to provide an apparatus that can distinguish between shots made by different shooters. It would be further desirable to provide an apparatus that also can facilitate competitive shooting in group environments and can send and receive instructions, data, and other information wirelessly to and from another device or through connection with internet. Additionally, it would be desirable to provide an apparatus and method of recording shots that does not rely on sound input only and to provide an apparatus that can be comfortably and easily worn on the shooter's wrist without interfering with normal training routines or other gear. It is in this context that the present embodiments arise.

### SUMMARY OF THE INVENTION

The present invention is a wearable shot activated timer system that senses and identifies shot recoil when a firearm has discharged in the hands of the wearer. It comprises a wearable housing, a power source, a display, control and processing components, a stopwatch, one or more input devices, a motion sensor, and activation signal components. It optionally further includes wireless communication components and audio sensors. The motion sensor comprises an accelerometer that detects the recoil vibration patterns when a firearm is discharged, and software installed on the control and processing components identifies valid firearm shots. The wireless communication components preferably facilitate communication between the timer system and a base unit using a short-range communication protocol, such as the Bluetooth® protocol or other radio frequency digital protocol. The wearable housing is preferably configured to be worn on a shooter's wrist, and the components are located within the housing or are attached to or integral with the housing. Additionally, the display, time measurement device, motion sensor, input device, activation signal components, audio sensor, and wireless communication components are each in communication with the control and processing components.

The shot activated timer system signals to the shooter with an audible sound or other signal produced by the activation signal components that indicates the stopwatch is beginning to record elapsed time. The shooter then proceeds to discharge his firearm one or more times sequentially. The system recognizes that a shot was fired by sensing the resulting vibrations with the motion sensor and then determining whether the vibrations comprise either a valid shot vibration pattern or an invalid shot vibration pattern. For each valid shot vibration, the system records the elapsed time associated with the valid shot vibration. The timer system can also optionally include audio sensors for sensing the sound produced when the firearm is discharged. The system can operate to detect a shot using only the motion sensor, using only the audio sensor, or using both the audio and motion sensor. The results are displayed on the display and optionally wirelessly communicated to the base station. Additionally, the timer system may wirelessly communicate with a base station or access the internet through its wireless communication components to further share the results or receive instructions, data, or other information.

### BRIEF DESCRIPTION OF THE DRAWINGS

FIG. 1 is a perspective view of the shot activated timer system of the present invention.

FIG. 2 is a schematic illustration of the shot activated timer system of the present invention.

FIG. 3 is a flowchart illustrating the method of timing shots with the shot activated timer system of the present invention.

FIG. 4 is an illustration of the data displayed on the shot activated timer system of the present invention.

FIG. 5 is a flowchart illustrating the method of timing shots for multiple shooters using a base station and multiple shot activated timer systems of the present invention.

### DETAILED DESCRIPTION OF PREFERRED EMBODIMENTS

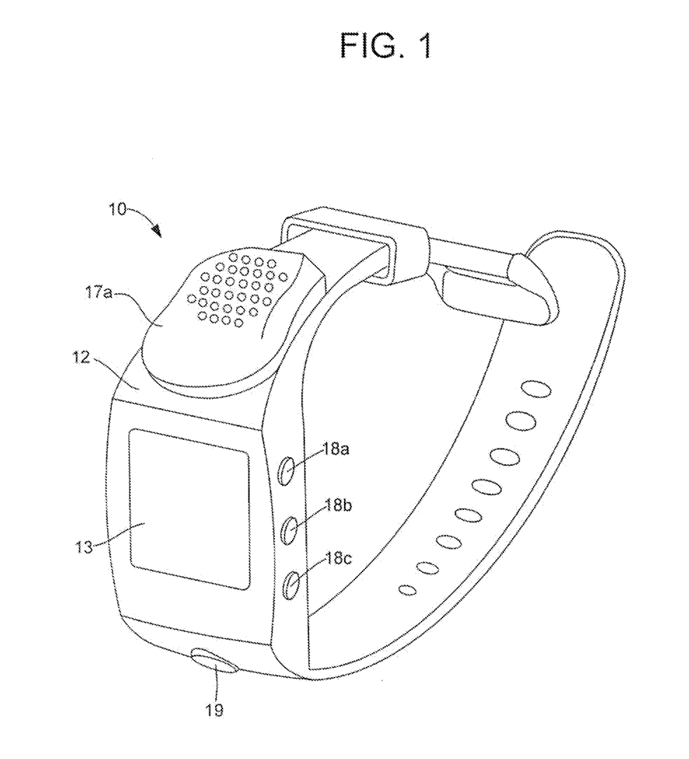

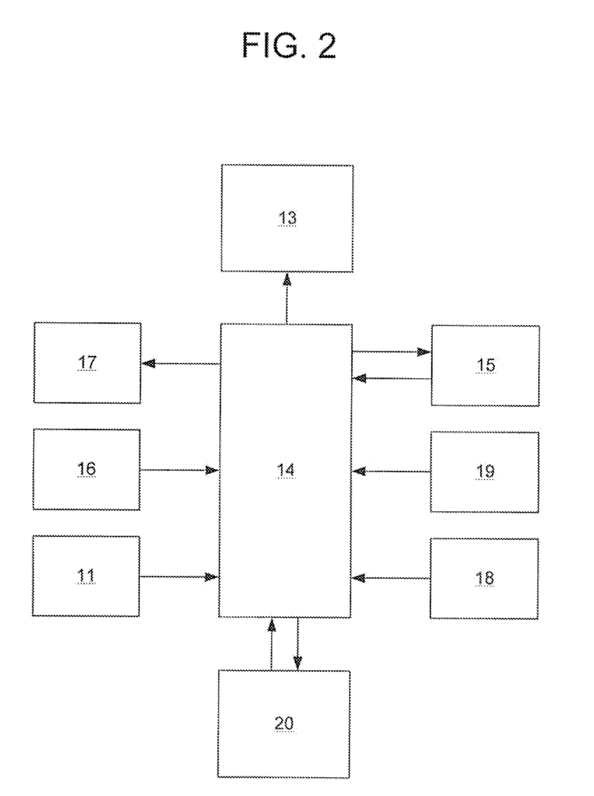

FIG. 1 illustrates the shot activated timer system 10 of the present invention. Timer system 10 comprises a wearable housing 12, a power source 11, a display 13, control and processing components 14, a stopwatch 15, a motion sensor 16, activation signal components 17, and one or more input devices 18. It optionally and preferably further includes audio sensors 19 and wireless communication components 20. Wireless communication components preferably wirelessly communicate with a base station 30. Display 13 and input devices 18 are preferably attached to or integral with housing 12 such that a shooter can readily view display 13 and access one or more user input devices 18 while wearing housing 12. Stopwatch 15, motion sensor 16, optional audio sensors 19, wireless communication components 20, and activation signal components 18 are preferably housed in wearable housing 12. Control and processing components 14 receive information from stopwatch 15, input device 18, audio sensors 19, motion sensor 16, and wireless communication components 20 via electrical communication. Control and processing components 14 send information to display 13, activation signal components 17, and wireless communication components 20 also via electrical communication. Power source 11 provides power for all of the timer system 10 components. FIG. 2 illustrates these elements and how they are in electrical communication with each other.

The power source 11 preferably provides direct current, such as that provided by a battery, but may instead provide alternating current such as that provided by conventional building outlet power (120V) that is then converted to direct current. The power supply 11 may be housed in the housing 12 or may be deployed separately with an electrical cable joining it thereto. Preferably, power supply 11 comprises a rechargeable battery located in housing 11 and accessible via a charge port (not shown) that can be recharged with standard alternating current. The charge port is preferably a micro USB block built in the housing that can also be used for software updates. A full charge will provide about 3 months of watch function (standby) and about 24 hours of use as a shot timer, with all sensors and wireless capabilities active.

Housing 12 preferably comprises a wristwatch as shown in FIG. 1. Housing 12 preferably is worn on the wrist of either the shooter/competitor or of a range officer at a shooting range or other range personnel. By wearing timer system 10 on the wrist, timer system 10 is easier to use, safer to use, and minimizes weight. Additionally, when worn by the shooter, the components of the system are in an ideal location to sense vibration and optionally sound produced by discharging a firearm. When worn by the range officer, he can have his hands free in case he needs to grab a shooter to prevent him from falling or turning. Housing 12 can be any type of wristwatch and can include any type of strap and clasp for securing the wristwatch to the shooter's wrist. For example, the wristwatch can be a substantially waterproof case with substantially waterproof plastic straps that are secured with a buckle. Alternatively, the wristwatch can include a stainless steel case with leather straps that attach with a hook and loop type of enclosure. Additionally, housing 12 can be any other type of wearable item suitable for housing components that detect nearby vibrations as will be known to someone skilled in the art to which this invention pertains.

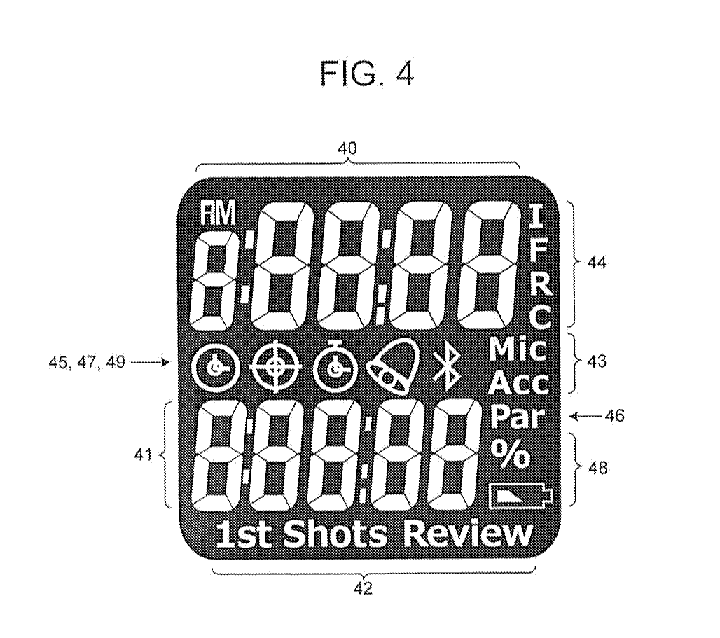

Display 13 preferably comprises a liquid crystal display (LCD) as known in the art. Any type of watch or other display may be used as long as it can convey numerical results. FIG. 4 illustrates the features preferably shown on display 13, which include icons indicating if the alarm is on 47, Bluetooth status 49, modes of operation 45, type of delays 44, type of active sensors 43, par setting status 46, and battery life remaining 48. Additionally, the display includes the main clock display 40, a split time display 41, and first shot/number of shots indicator 42. Input devices 18 comprise one or more buttons, a touch screen, joystick, trackball, microphone, keyboard, or any other type of input device as is known in the art. Input devices 18 allow a shooter to turn system 10 on or off, to select an activation delay type, to select par, to input data about the shooter, to input other data, to choose between programs, to navigate through results, and to access additional features of system 10. Additional input devices can be used to allow the shooter to select between the audio sensor or motion sensor, to set the level of sensitivity for the sensors, to input and set the clock and date, to set the volume of the audio signal or beep, to use review features and review shots recorded, to link by Bluetooth to other devices, and to turn a backlight on or off. Preferably, as shown in FIG. 1, input devices 18 include a start timer button 18a, a illuminate backlight button 18b, a review split times button 18c, as well as a mode button (not shown), and a setting button (not shown). Appropriate input devices are well known in the art to which this invention pertains.

Control and processing components 14 preferably comprise various discrete circuits, as is known in the art. For example, the control and processing components 14 include control circuitry for operating the display 13, input devices 18, stopwatch 15, audio sensors 19, wireless communication components 20, activation signal components) 7, and motion sensor 16. In a further form, the control and processing components include a microprocessor programmed to operate in various modes and additional elements of a computer system such as, memory, storage, an input/output interface, a communication interface, and a bus, as is well known in the art. Software for generally operating timer system 10 is installed on the control and processing components 14. Pattern recognition software for determining valid shot patterns is installed on the control and processing components 14 as well.

Stopwatch 15 is a digital clock or any type of time measurement device. Preferably, stopwatch 15 comprises circuit components configured to allow measurement of elapsed time as is known to someone skilled in the art. Preferably stopwatch 15 is further configured with a control circuit for starting, stopping, and resetting the elapsed time measurement. Stopwatch 15 preferably records the overall elapsed time from an activation signal until the session is ended and also the elapsed time between individual shots (splits). Stopwatch 15 also preferably measures actual time such that a timestamp can be associated with each shot timer session. In addition to stopwatch 15, a conventional digital watch or conventional digital watch components can also be incorporated into timer system 10.

The preferred activation signal components 17 for creating an activation or start signal comprise a biaxially oriented polyethylene terephthalate (BOPET) polyester film speaker (Mylar® speaker) or piezoelectric sound component. Preferably, the speaker or sound component are housed in a sound chamber 17a that is integral with or attached to the housing 12. Mylar® speakers and piezoelectric sound components are significantly smaller than sound components in currently available shot timer systems and are particularly well suited for use with the wearable shot activated timer system 10 of the present invention. The activation signal component is Mylar® speaker Model No. SXI20N-A from Changzhou Duoxing Electronics Co., Ltd. of China. By placing the small activation signal components 17 in sound chamber 17 the sound of the activation signal can reach a volume of 110 db. The activation signal components can also be used to produce an audible signal at regular intervals according to the par setting and details selected.

The preferred motion sensor 16 for system 10 is an accelerometer. More preferably, the accelerometer is an ultra-low power 3-axis hi resolution accelerometer such as the 3-axis, ±2 gl+4 gl+8 gl+16 digital accelerometer ADXL345 from Analog Devices, Inc. The internal accelerometer records vibration patterns which it provides through electrical communication with the control circuitry to software capable of determining whether a given pattern is a valid shot or an invalid shot.

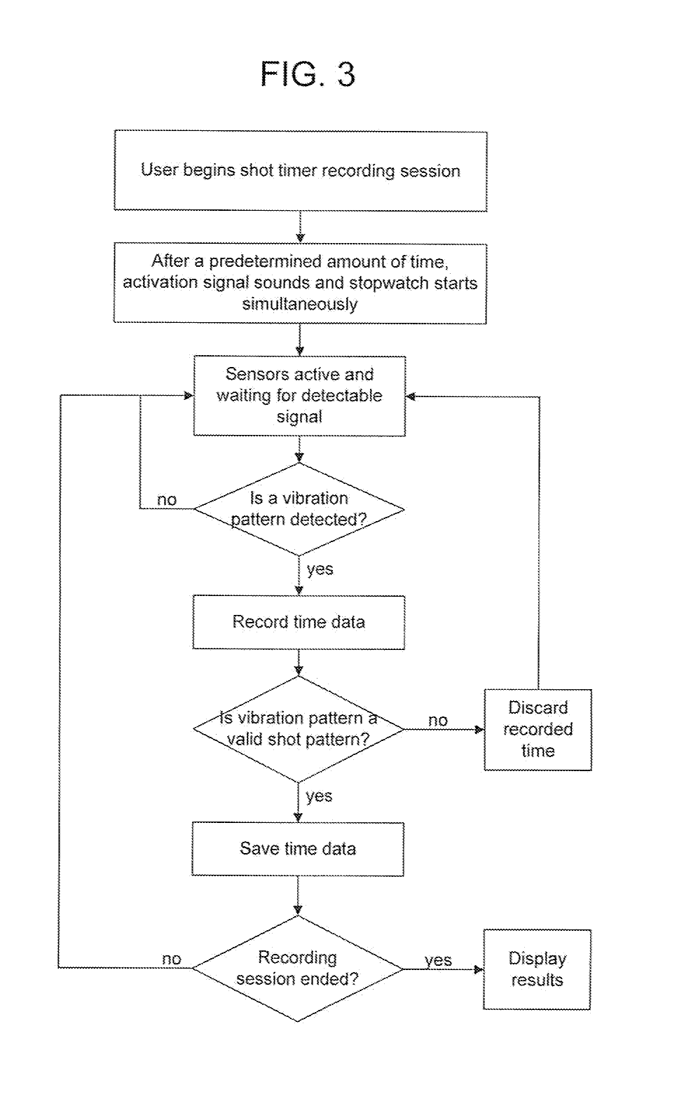

Using the pattern recognition software preferably installed on control and processing components 14, invalid shots and other vibration types such as hand movements, are filtered out. FIG. 3 illustrates how a valid shot is determined with timer system 10 and motion sensor 16. The pattern recognition software compares the vibration pattern sensed by motion sensor 16 to the vibration patterns of many types of firearms. Accordingly, the pattern recognition software can discern whether a vibration pattern is typical for a pistol or rifle or if it indicates a shot by a much smaller caliber firearm. This is distinct advantage of the present invention over currently available shot timer systems that are unable to detect discharges by smaller caliber firearms such as airsoft guns or pressurized gas guns, which are extensively used in competition in many countries, due to their less audible discharge. Additionally, by incorporating an accelerometer, the present invention also allows multiple shooters each using a shot activated timer system 10 to discharge their firearms near each other without the risk of one timer system 10 detecting shots fired by another shooter or shooters. Currently available shot timer systems are unable to accomplish this without significant errors.

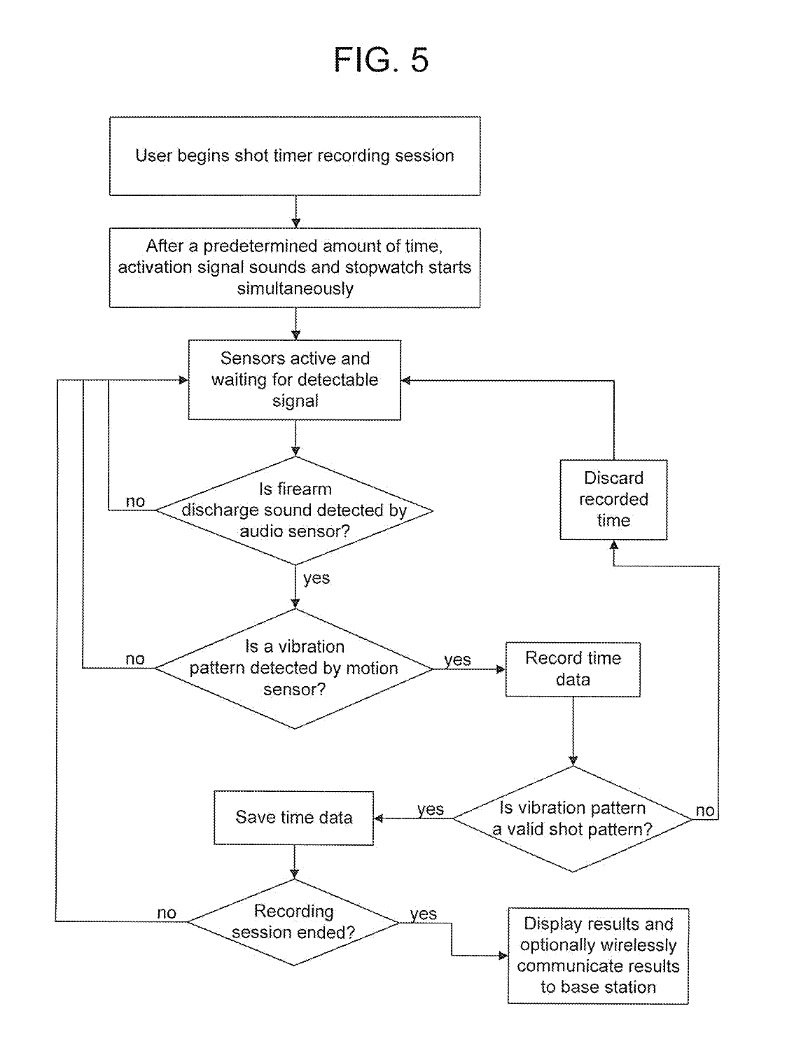

In addition to using motion sensor 16 to identify valid shots, system 10 can optionally include audio sensors 19. The preferred embodiment of the timer system of the present invention includes both motion sensor 16 and an audio sensor 19. Audio sensors 19 preferably comprise one or more microphones with multiple sensitivity adjustments as is known in the art to which this invention pertains. When both motion sensor 16 and an audio sensor 19 are present in system 10, the shooter can select whether to use one type of sensor or the other depending on the shooting environment. Further, the shooter can elect to use both types of sensors simultaneously to increase the reliability of the shot activated timer system. FIG. 5 illustrates how a valid shot is determined when both sensors are selected.

Optional wireless communication components 20 preferably comprise components for facilitating two-way communication according to a short-range communication protocol, such as the Bluetooth® protocol or other radio frequency digital protocol. Bluetooth wireless communication components are well known in the art to which this invention pertains. While currently available shot timers use simple one-way RF (Radio Frequency) communication to send (or mirror) the recorded shots onto an external display, the present invention can send and receive data such as shot times, shot numbers, delay settings, par settings, time of the day which the shot was recorded and more. Additionally, the present invention can further receive information and instructions that facilitate remote control of the shot activated timer system's features. For example, through a base station 30 such as a smart phone, a shooter, range master, or other personnel can remotely turn system 10 on or off, select an activation delay type, select par, and input data about the shooter, input other data, choose between programs, navigate through results, and access additional features of system 10. The base station can also be used to send a start signal to the timers on individual timer systems 10 and thereby activate the timer on each system 10. Additionally, timer system 10 can receive updates wirelessly for it software and can connect to additional users and programs by accessing the internet through its wireless connection.

Base station 30 can be any type of computer system such as a personal computer, tablet, or smart phone, and preferably includes a display, one or more input devices, control and processing components, and wireless communication components that allow it to simultaneously communicate with a plurality of timing systems 10. Base station 30 can be a dedicated base station that only communicates with timing systems 10 or it can be a device that is used for many other purposes and simply includes software or applications for communicating with and processing results from timing systems 10. Preferably, base station 30 can access the internet and accordingly can provide remote access to the internet for timer system 10.

Through wireless communication with one or more timing systems 10, base station 30 can be used to collect data received from one or more timing systems 10, and to generate reports, results, and statistics in real time, which is particularly useful in competitions or competitive environments with multiple shooters. Additionally, because base stations 30 may have significantly more computing capabilities than available on shot timers, base stations 30 can include sophisticated software or applications for enhanced analysis of the data generated by timing systems 10. In competitive shooting environments, base station 30 can be particularly useful for sending uniform instructions to all of the timing systems 10 used by the competing shooters. Accordingly, the activation signal can be synchronized among all of the timing systems 10 so that all of the competing shooters begin at the same time.

To use the timing system 10 of the present invention, using one or more input devices 18, a shooter selects variables such as activation delay, par, and optionally which type of sensor to use if multiple sensors are available. Next, when ready, the shooter starts a recording session by using input devices 18. A recording session for purposes of this application is the time after which a shooter or remote operator tells system 10 to begin recording shots until either the shooter or remote operator tells the system 10 to stop recording shots or until a predetermined number of seconds have elapsed. To start the recording session, for example, the shooter presses the input device 18 designated to start a recording session. Similarly, to end or stop a recording session, for example, the shooter again presses the input device 18 for starting a new session or presses the input device 18 designated to begin a review of the recorded data. Typical recording sessions will be under 1 minute but can be as long as 10 minutes. After the selected activation delay, the activation signal is produced from activation signal components 17 and stopwatch 15 is started. The shooter proceeds to discharge his firearm one or more times and timing system 10 senses the shots with motion sensor 16 and/or audio sensors 19 and records the time data from stopwatch 15. When the recording session ends either because the maximum recording length has been reached or because the shooter stopped the session using input devices 18, the collected data is analyzed with software installed on control and processing components 18, and the results are displayed on display 12.

To use the timing system 10 of the present invention with a remote base station 30, using one or more input devices 18 or through wireless communication with base station 30, a shooter or other person selects variables such as activation delay, par, and optionally which type of sensor to use if multiple sensors are available. Next, when ready, the shooter or other person starts the recording session again by using input devices 18 or through wireless communication with base station 30. After the selected activation delay, the activation signal is produced from activation signal components 17 and stopwatch 15 is started. The shooter proceeds to discharge his firearm one or more times and timing system 10 senses the shots with motion sensor 16 and/or audio sensors 19 and records the time data from stopwatch 15. When the recording session ends either because the maximum recording length has been reached or because the shooter elected to manually end the session using input devices 18, the collected data is analyzed with software installed on control and processing components 18, optionally displayed on display 12, and optionally wirelessly communicated to base station 30 for display and further analysis.

To use multiple timing systems 10 of the present invention with a remote base station 30 in a competitive environment, through wireless communication with base station 30, a range master selects variables such as activation delay, par, and optionally which type of sensor to use if multiple sensors are available. The selections are wireless communicated to each of the multiple timing systems 10. When ready, the range master simultaneously starts the recording sessions for each of timer systems 10 through wireless communication with base station 30. After the selected activation delay, the activation signal is produced from activation signal components 17 and stopwatch 15 is started. The shooters proceed to discharge their firearms one or more times and each shooter's timing system 10 senses his shots with motion sensor 16 and records the time data from stopwatch 15. When the recording sessions end, the collected data is processed with software installed on control and processing components 18, optionally displayed on display 12, and wirelessly communicated to base station 30 for display and further analysis.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

I claim:

1. A shot activated timer system comprising:
a. a wearable housing;
b. control and processing components disposed in the housing;
c. a stopwatch disposed in the housing and in electrical communication with the control and processing components;
d. a motion sensor disposed in the housing and in electrical communication with the control and processing components;
e. an activation signal component attached to the housing and in electrical communication with the control and processing components;
f. a display attached to the housing and in electrical communication with the control and processing components; and
g. at least one input device attached to the housing and in electrical communication with the control and processing components.

2. The shot activated timer system of claim 1 further comprising an audio sensor disposed in the housing and in electrical communication with the control and processing components.

3. The shot activated timer system of claim 1 further comprising wireless communication components disposed in the housing and in electrical communication with the control and processing components.

4. The shot activated timer system of claim 2 further comprising wireless communication components disposed in the housing and in electrical communication with the control and processing components.

5. The shot activated timer system of claim 1 further comprising a sound chamber disposed on the housing and configured to house the activation signal component.

6. The shot activated timer system of claim 1 wherein the motion sensor comprises an accelerometer.

7. The shot activated timer system of claim 1 wherein the sound activation component comprises a biaxially oriented polyethylene terephthalate polyester film speaker.

8. The shot activated timer system of claim 1 wherein the housing is configured to be worn around the user's wrist.

9. The shot activated timer system of claim 3 wherein the wireless communication components comprise components configured to enable two-way communication according to a short-range communication protocol.

10. A shot activated timer system comprising:
a. a housing configured to be worn on the user's wrist;
b. control and processing components disposed in the housing;
c. a stopwatch disposed in the housing and in electrical communication with the control and processing components;
d. an accelerometer disposed in the housing and in electrical communication with the control and processing components;
e. a sound chamber attached to the housing;
f. a biaxially oriented polyethylene terephthalate polyester film speaker disposed in the sound chamber and in electrical communication with the control and processing components;
g. a liquid crystal display attached to the housing and in electrical communication with the control and processing components;
h. at least one input device attached to the housing and in electrical communication with the control and processing components;
i. an audio sensor disposed in the housing and in electrical communication with the control and processing components; and
j. wireless communication components disposed in the housing and in electrical communication with the control and processing components wherein the wireless communication components comprise components configured to enable two-way communication according to a short-range communication protocol.

11. A method for detecting discharges from a firearm comprising:
a. securing on the wrist of a shooter a shot activated timer system comprising:
i. a wearable housing;
ii. control and processing components disposed in the housing;
iii. a stopwatch disposed in the housing and in electrical communication with the control and processing components;
iv. a motion sensor disposed in the housing and in electrical communication with the control and processing components;
v. an activation signal component attached to the housing and in electrical communication with the control and processing components;
vi. a display attached to the housing and in electrical communication with the control and processing components; and
vii. at least one input device attached to the housing and in electrical communication with the control and processing components;
b. selecting the desired activation delay and par;
c. starting a recording session after selecting the desired activation delay and par;
d. sounding the activation signal and starting the stopwatch after the recording session has started and the activation delay has elapsed;
e. sensing with the motion sensor each discharge of the shooter's firearm after the recording session has started;
f. recording the time data associated with each discharge of the shooter's firearm; and
g. stopping the recording session after the maximum recording length has been reached or the shooter affirmatively ends the session by using input devices on the shot timer system.

12. The method for detecting discharges from a firearm of claim 11 further comprising compiling time data results after the recording session has been stopped, wherein time data results are compiled by analyzing the collected time data with software installed on the control and processing components of the shot timer system.

13. The method for detecting discharges from a firearm of claim 12 further comprising displaying time data and time data results on the shot timer system display after a session has been stopped and in response to the shooter selecting to review data using an input device on the shot timer system.

14. The method for detecting discharges from a firearm of claim 12 wherein:
a. the shot timer system further comprises wireless communication components disposed in the housing and in electrical communication with the control and processing components; and
b. the method further comprises wirelessly communicating time data and time data results to a base station.

15. The method for detecting discharges from a firearm of claim 11 wherein:
a. the shot timer system further comprises wireless communication components disposed in the housing and in electrical communication with the control and processing components; and
b. the method further comprises using a base station to wirelessly communicate to the shot timer system instructions to start a recording session.

16. The method for detecting discharges from a firearm of claim 11 wherein:
a. the shot timer system further comprises wireless communication components disposed in the housing and in electrical communication with the control and processing components; and
b. the method further comprises using a base station to wirelessly communicate to the shot timer system the activation delay and par settings.

17. The method for detecting discharges from a firearm of claim 11 wherein:
a. the shot timer system further comprises an audio sensor disposed in the housing and in electrical communication with the control and processing components; and
b. the method further comprises sensing with the motion sensor and audio sensor each discharge of the shooter's firearm after the recording session has started.

18. The method for detecting discharges from a firearm of claim 11 wherein:
a. the shot timer system further comprises an audio sensor disposed in the housing and in electrical communication with the control and processing components; and
b. the method further comprises:
i. selecting whether to sense shots with the audio sensor, motion sensor, or both the audio sensor and motion sensor; and
ii. sensing with the selected sensors each discharge of the shooter's firearm after the recording session has started.

19. The method for detecting discharges from a firearm of claim 11 wherein the steps of sensing with the motion sensor each discharge of the shooter's firearm after the recording session has started and recording the time data associated with each discharge of the shooter's firearm comprise:
a. sensing vibration patterns produced when the shooter discharges the firearm;
b. after sensing the vibration patterns, using pattern recognition software installed on the control and processing components of the shot timer system to identify whether the vibration pattern represents a valid shot or other vibration patterns; and
c. after identifying valid shots or other vibration patterns, recording the time data associated with identified valid shots and discarding time data associated with other vibration patterns.

20. The method for detecting discharges from a firearm of claim 17 wherein the steps of sensing each discharge of the shooter's firearm after the recording session has started and recording the time data associated with each discharge of the shooter's firearm comprise:
a. sensing with the audio sensor sounds produced when the shooter discharges a firearm;
b. simultaneously with sensing firearm discharge sounds, sensing with the motion sensor vibration patterns produced when the shooter discharges the firearm;
c. if both an firearm discharge sound and a vibration pattern are sensed, using pattern recognition software installed on the control and processing components of the shot timer system to identify whether the vibration pattern represents a valid shot or other vibration patterns; and
c. after identifying valid shots or other vibration patterns, recording the time data associated with identified valid shots and discarding time data associated with other vibration patterns.
